(19) United States
(12) Patent Application Publication
(10) Pub. No.: US 2003/0127826 A1
(43) Pub. Date: Jul. 10, 2003

(54) Method and device for releasing a fifth wheel hitch

(76) Inventor: Dale Clemence, Kindersley (CA)

Correspondence Address: Law Office of Albetrt Wai-Kit Chan, LLC, World Plaza, Suite 604, 141-07 20th Avenue, Whitestone, NY, 11357, US

(21) Appl. No.: 10/339,001

(22) Filed: Jan. 9, 2003

(30) Foreign Application Priority Data
Jan. 10, 2002 (CA) 2,367,239

(51) Int. Cl. B62D 53/06; B65G 7/12

(52) U.S. Cl. 280/433; 294/26

(57) ABSTRACT

A method of releasing a trailer from a fifth wheel hitch assembly comprises providing a rigid member adapted at a first end to releasably engage a lock release lever of the fifth wheel hitch assembly. A flexible tether is attached to the rigid member on one end and to a handle on the other end. The tether is non-resilient such that same is resistant to stretching. The second end of the rigid member is grasped and manipulated to engage the first end with the lock release lever while standing at a front end of the attached trailer; then the grasping hand is slid along the tether to the handle and grasps the handle. The handle is moved toward the rigid member to provide some slack in the tether and then jerked away from the rigid member, thereby moving the lock release lever to a released position.

This application claims priority of Canadian Incomplete Patent Application Serial No. 2,367,239, filed on Jan. 10, 2002, the content of which is incorporated by reference here into this application.

This invention is in the field of fifth wheel semi-trailer vehicles and in particular the attachment and release of such semi-trailers from a towing vehicle.

### BACKGROUND OF THE INVENTION

Semi-trailers are most commonly hitched to highway tractors by means of a fifth wheel hitch. The fifth wheel hitch assembly comprises an upper portion attached to the semi-trailer, comprising an upper plate with a pin extending down from the center of the plate, and a lower portion attached to the tractor comprising a lower plate with a slot extending rearward. To connect the semi-trailer, the tractor is backed up so that the pin passes through the slot and is locked into the end of the slot. To disconnect the semi-trailer, a lock release lever must be pulled in a direction generally lateral toward the left driver's side of the semi-trailer to release the pin so that the tractor can be moved ahead and out of engagement with the semi-trailer. It can take considerable force to move the lock release lever and release the pin on the semi-trailer.

The lock release lever is located on the lower portion of the hitch assembly under the front end of the semi-trailer. Typically the operator must stretch to reach the lock release lever. A jerking motion is preferred however it is difficult to jerk the lock release lever because of its position. Rigid extensions are commercially available that comprise a long shaft with a hook on the end to engage the lock release lever. The shaft is long enough to allow the operator to stand beside the semi-trailer and reach in to engage the lock release lever. Only a small jerking action on the lock release lever is possible by moving the hook past the lock release lever and then jerking it towards the operator. Such rigid devices are too long to conveniently store in the tool boxes or compartments usually available on highway tractors, and so must be hung on the exterior of the vehicle where they are subject to loss, theft, and so forth.

### SUMMARY OF THE INVENTION

It is the object of the present invention to provide an improved device for moving a lock release lever on a fifth wheel hitch assembly to disconnect a semi-trailer from a tractor.

It is a further object of the invention to provide such a device that can be readily attached from a front end of the trailer, and allows the operator to move to a position beside the semi-trailer and jerk the lock release lever. It is a further object of the invention to provide such a device that is compact and readily stored in a tool box or the like.

The invention provides, in a first aspect, a device for releasing a trailer from a fifth wheel hitch assembly. The device comprises a rigid member adapted at a first end to releasably engage a lock release lever of the fifth wheel hitch assembly, the rigid member having a length sufficient to allow an operator to engage the first end with the lock release lever while grasping a second end of the rigid member and while standing at a front end of a trailer attached to the fifth wheel hitch assembly. A flexible tether is attached at a first end thereof to the second end of the rigid member, wherein the tether is non-resilient such that same is resistant to stretching. A handle is attached to a second end of the tether, and the tether has a length sufficient to allow the operator to grasp the handle from a position beside the trailer with at least some slack in the tether such that the operator can jerk the handle to move the lock release lever to a released position.

The invention provides, in a second aspect, a method of releasing a trailer from a fifth wheel hitch assembly. The method comprises providing a rigid member adapted at a first end to releasably engage a lock release lever of the fifth wheel hitch assembly; attaching a first end of a flexible tether to a second end of the rigid member, and attaching a second end of the flexible tether to a handle, wherein the flexible tether is non-resilient such that same is resistant to stretching; grasping a second end of the rigid member and engaging the first end of the rigid member with the lock release lever while standing at a front end of a trailer attached to the fifth wheel hitch assembly; sliding a grasping hand along the tether to the handle while moving to a side of the trailer; grasping the handle and moving the handle toward the rigid member to provide at least some slack in the tether; and jerking the handle away from the rigid member, thereby moving the lock release lever to a released position.

The tether can be a chain, wire cable, or rope that will not stretch. A firm jerk is required, and a resilient tether will give longitudinally instead of jerking.

The flexible chain allows the device to be stored in a tool box that is only as long as the rigid member. Conventional rigid release devices will not fit in most tool boxes and so must be stored on the truck floor or hung on an exterior rack where they may be lost or stolen. The flexible tether further allows the operator to roll the handle and wind a portion of the length of the tether around the handle to allow use of the device where the trailer is parked close to a wall or the like where space is limited.

### DETAILED DESCRIPTION OF THE FIGURES

While the invention is claimed in the concluding portions hereof, preferred embodiments are provided in the accompanying detailed description which may be best understood in conjunction with the accompanying diagrams where like parts in each of the several diagrams are labeled with like numbers, and where:

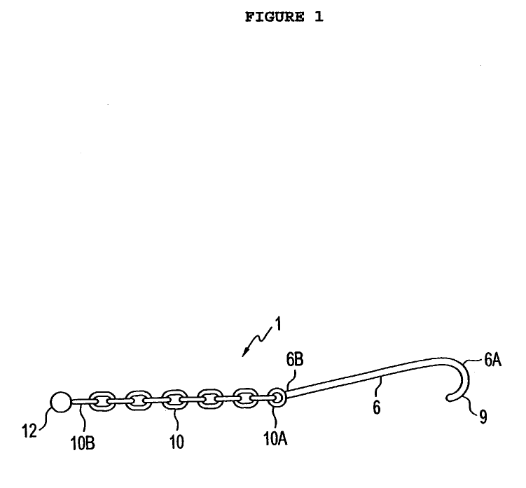

FIG. 1 is a side view of an embodiment of the invention;

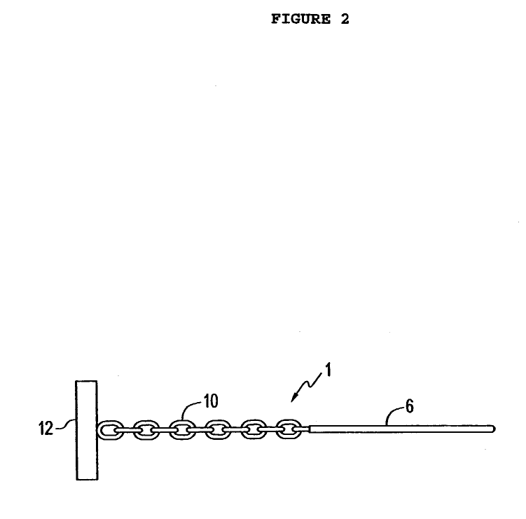

FIG. 2 is a top view of the embodiment of FIG. 1;

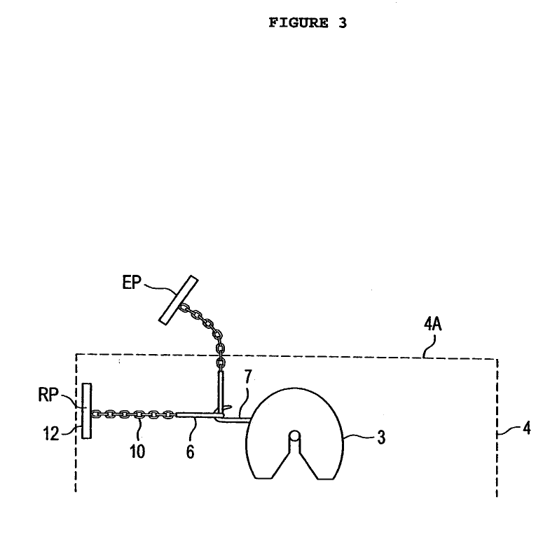

FIG. 3 is a schematic top view of the embodiment of FIG. 1 in use on a fifth wheel hitch assembly, with the semi-trailer above the hitch indicated by phantom lines;

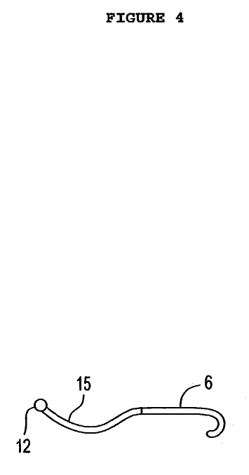

FIG. 4 is a side view of an alternate embodiment of the invention using a cable or rope as a tether instead of a chain.

### DETAILED DESCRIPTION OF THE INVENTION

This invention disclosed herein provides a device for releasing a trailer from a fifth wheel hitch assembly comprising: A rigid member adapted at a first end to releasably engage a lock release lever of the fifth wheel hitch assembly, the rigid member having a length sufficient to allow an operator to engage the first end with the lock release lever while grasping a second end of the rigid member and while standing at a front end of a trailer attached to the fifth wheel hitch assembly; a flexible tether attached at a first end thereof to the second end of the rigid member, wherein the tether is non-resilient such that same is resistant to stretching; a handle attached to a second end of the tether, and the tether having a length sufficient to allow the operator to grasp the handle from a position beside the trailer with at least some slack in the tether such that the operator can jerk the handle to move the lock release lever to a released position.

In an embodiment, the flexible tether comprises one of a chain, a wire cable, and a rope. In the further embodiment, the handle comprises an elongate bar, and wherein the flexible tether is attached to a mid-point of the bar. In a embodiment, the bar has a substantially circular cross section.

This invention also provides a method of releasing a trailer from a fifth wheel hitch assembly comprising: providing a rigid member adapted at a first end to releasably engage a lock release lever of the fifth wheel hitch assembly; attaching a first end of a flexible tether to a second end of the rigid member, and attaching a second end of the flexible tether to a handle, wherein the flexible tether is non-resilient such that same is resistant to stretching; grasping a second end of the rigid member and engaging the first end of the rigid member with the lock release lever while standing at a front end of a trailer attached to the fifth wheel hitch assembly; sliding a grasping hand along the tether to the handle while moving to a side of the trailer; grasping the handle and moving the handle toward the rigid member to provide at least some slack in the tether; jerking the handle away from the rigid member, thereby moving the lock release lever to a released position. In an embodiment, the flexible tether comprises one of a chain, a wire cable, and a rope. In a further embodiment, the handle comprises an elongate bar, and wherein the flexible tether is attached to a mid-point of the bar, and wherein the handle is grasped by a hand on each side of the handle. In an embodiment the bar has a substantially circular cross section. In a separate embodiment, the invention further comprises rolling the tether up on the handle to effectively reduce the length of the chain prior to jerking the handle.

FIGS. 1 and 2 illustrate an embodiment of the invention, a device 1 for releasing a trailer from a fifth wheel hitch assembly. The device 1 is shown in FIG. 3 in use on a fifth wheel hitch assembly 3, shown as is typical located under the front end of an attached semi-trailer 4.

A rigid member 6 is adapted at a first end 6A to engage the lock release lever 7 of the fifth wheel hitch assembly 3 with a hook 9. The rigid member 6 is long enough to allow the operator to hold the second end 6B of the rigid member 6 and reach in from the front of the semi-trailer and engage the hook 9 with the lock release lever 7, as indicated in FIG. 3 by the engaging position EP. To release the lock release lever 7, it is necessary to pull it away from the fifth wheel hitch assembly 3, or towards the left as seen in the top view of FIG. 3, into a released position.

A first end 10A of a chain 10 is attached to the second end 6B of the rigid member 6. A handle 12 is attached to the second end 10B of the chain 10. The chain 10 is of sufficient length that the operator can grasp the handle 12 from a position beside the trailer 4, as indicated in FIG. 3 by the releasing position RP, with at least some slack in the chain 10 such that the operator can jerk the handle 12 to move the lock release lever 7 to a released position. The operator can stand beside the semi-trailer 4 and grasp the handle 12 with both hands. Using the slack provided by the chain 10, the operator can exert an effective jerking force on lock release lever 7.

The chain 10 could be replaced with any flexible tether, such as a wire cable or rope 15 as illustrated in FIG. 4, that will facilitate the jerking motion desired on the lock release lever 7. Such an alternate tether, like the chain 10, will be non resilient, such that it is resistant to stretching.

Good results have been obtained with a rigid member 6 of about 26 inches in length, and a chain 10 of about 20 inches in length. The rigid member 6 is long enough to allow the operator to conveniently engage the hook 9 on the lock release lever 7 while standing at the front of the trailer 4 as shown by position EP. When in the releasing position RP, the handle 12 is then just under the semi-trailer 4, convenient for jerking by the operator. The dimensions can be varied to suit individual preferences. In the illustrated embodiments the handle 12 is a bar with a substantially circular cross section for comfortable grasping.

The trailer 4 is released from the fifth wheel hitch assembly 3 by grasping the second end 6B of the rigid member 6 and engaging the first end 6A with the lock release lever 7 while standing at a front end 4A of a trailer 4 attached to the fifth wheel hitch assembly 3; then sliding a grasping hand along the chain 10 to the handle 12 while moving to a side of the trailer 4; then grasping the handle 12, preferably with two hands to provide added force, and moving the handle 12 toward the rigid member 6 to provide at least some slack in the chain 10; then jerking the handle 12 away from the rigid member 6, thereby moving the lock release lever 7 to the released position. Where the operator is in a laterally confined space, the chain 10 can be rolled up on the handle 12 to effectively reduce the length of the chain.

For storage the device 1 can be placed in a tool box or the like that is only as long as the rigid member 6.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A device for releasing a trailer from a fifth wheel hitch assembly comprising:
a. a rigid member adapted at a first end to releasably engage a lock release lever of the fifth wheel hitch assembly, the rigid member having a length sufficient to allow an operator to engage the first end with the lock release lever while grasping a second end of the rigid member and while standing at a front end of a trailer attached to the fifth wheel hitch assembly;
b. a flexible tether attached at a first end thereof to the second end of the rigid member, wherein the tether is non-resilient such that same is resistant to stretching;
c. a handle attached to a second end of the tether, and the tether having a length sufficient to allow the operator to grasp the handle from a position beside the trailer with at least some slack in the tether such that the operator can jerk the handle to move the lock release lever to a released position.

2. The device of claim 1 wherein the flexible tether comprises one of a chain, a wire cable, and a rope.

3. The device of claim 1 wherein the handle comprises an elongate bar, and wherein the flexible tether is attached to a mid-point of the bar.

4. The device of claim 3 wherein the bar has a substantially circular cross section.

5. A method of releasing a trailer from a fifth wheel hitch assembly comprising:
a. providing a rigid member adapted at a first end to releasably engage a lock release lever of the fifth wheel hitch assembly;
b. attaching a first end of a flexible tether to a second end of the rigid member, and attaching a second end of the flexible tether to a handle, wherein the flexible tether is non-resilient such that same is resistant to stretching;
c. grasping a second end of the rigid member and engaging the first end of the rigid member with the lock release lever while standing at a front end of a trailer attached to the fifth wheel hitch assembly;
d. sliding a grasping hand along the tether to the handle while moving to a side of the trailer;
e. grasping the handle and moving the handle toward the rigid member to provide at least some slack in the tether;
f. jerking the handle away from the rigid member, thereby moving the lock release lever to a released position.

6. The method of claim 5 wherein the flexible tether comprises one of a chain, a wire cable, and a rope.

7. The method of claim 5 wherein the handle comprises an elongate bar, and wherein the flexible tether is attached to a mid-point of the bar, and wherein the handle is grasped by a hand on each side of the handle.

8. The method of claim 7 wherein the bar has a substantially circular cross section.

9. The method of claim 5 further comprising rolling the tether up on the handle to effectively reduce the length of the chain prior to jerking the handle.
